(19) United States
(12) Patent Application Publication
(10) Pub. No.: US 2025/0024985 A1
(43) Pub. Date: Jan. 23, 2025

(54) MACHINE AND METHOD FOR PREPARING A BREWED DRINK

(71) Applicant: Melitta Single Portions GmbH & Co. KG, Minden (DE)

(72) Inventors: Jan PAHNKE, Minden (DE); Christopher ZUM BRUCH, Köln (DE)

(73) Assignee: Melitta Single Portions GmbH & Co. KG, Minden (DE)

(21) Appl. No.: 18/715,223

(22) PCT Filed: Nov. 15, 2022
(86) PCT No.: PCT/EP2022/081913

§ 371 Date: May 31, 2024

(30) Foreign Application Priority Data
Dec. 7, 2021 (DE) 10 2021 132 206.5

(51) Int. Cl. A47J 31/44; A47J 31/54

(52) U.S. Cl. CPC A47J 31/4492; A47J 31/54

(57) ABSTRACT

A machine for the preparation of a brewed beverage includes a device for the generation of hot water, which is operable via a controller, a holder for a portion pack with an extraction material, wherein the holder is arranged below an supply line for the hot water, and a recognition unit, wherein the recognition unit includes a proximity sensor, via which a first shape of the portion pack and a second shape of the portion pack, which is changed from the first shape, can be detected in a contactless manner.

The present invention relates to a machine for the preparation of a brewed beverage, including a device for the generation of hot water, which is operable via a controller, a holder for a portion pack with an extraction material, the holder being arranged under a supply line for the hot water, and a recognition unit. Furthermore, the invention relates to a method for preparing a brewed beverage comprising the following steps: inserting a portion pack with an extraction material into a holder of a machine for preparing a brewed beverage, and introducing hot water via a supply line onto the extraction material in the portion pack and preparing a brewed beverage.

WO 2019/141871 discloses a portion pack comprising a container of filter material in which an extraction material is arranged. The portion pack can be opened automatically in a machine for the preparation of a brewed beverage in order to then dispense hot water onto the extraction material in the portion pack. For such portion packs, it is known to provide a recognition unit so that a certain type of portion pack is recognised, for example to be able to set the brewing quantity or the brewing temperature or other parameters during beverage preparation. A disadvantage of preparing a brewed beverage with such a portion pack is that the sequence of the individual process steps during preparation is insufficiently detected. For example, if the opening is inadequate, a supply of hot water can occur without completely wetting the extraction material. In addition, errors in detection can lead to undesired programme sequences, which can also increase the risk of injury from hot water.

It is therefore the problem to be solved by the present invention to provide a machine and a method for the preparation of a brewed beverage which have increased reliability in the production of a brewed beverage.

This problem is solved by a machine with the features of claim 1 and a method with the features of claim 10.

In the machine according to the invention, the recognition unit includes a proximity sensor, via which a first shape of the portion pack and a second shape of the portion pack, which deviates from the first shape, can be detected, so that different shapes of the portion pack can be used for controller of the machine. This enables not only a possible detection of a capsule type, but also a contactless detection of at least one area of the outer shape of the portion pack that corresponds to a certain state during the brewing procedure. This allows the brewing procedure to be monitored more closely in order to better prevent incorrect operations.

The first and second shapes of the portion pack correspond to outer shapes that correspond to a certain state of the portion pack during the preparation process and can be detected by the proximity sensor. For example, the first shape of the portion pack can correspond to a closed state of the portion pack before the actual brewing procedure. The shape of the closed portion pack differs from an open portion pack, for example, because in the open position one or more closure elements have been moved from the closed position to the open position. In particular, one or more closure elements, in particular flaps, can be provided on a top side of the portion pack in the inserted position, which swivel into an opening position during the opening process, for example by at least 90°. This swivelling process can preferably be detected via the proximity sensor, at least in certain areas, in order to be able to recognise whether the closure elements have been swivelled sufficiently and are therefore opened. Insufficient swivelling of the closing elements in the opening direction can thus be detected.

Preferably, a third shape of the portion pack corresponds to an opened state after the brewing procedure. During the brewing procedure, water is added to the extraction material, in particular coffee or tea, so that the extraction material swells and has a different volume than before the brewing procedure. This volume change can be detected by the proximity sensor in order to be able to detect whether the portion pack arranged in the holder of the machine is already used or not.

Various sensors can be used as proximity sensors that enable contactless detection of the outer shape of the portion pack. For example, at least one capacitive sensor can be used, which detects a change in shape as a proximity sensor via the change in capacitance. Optionally, several capacitive sensors can also be arranged around the portion pack. The capacitive sensors can be used, for example, to detect the opening of a closure element or a volume change in the extraction material. Alternatively or additionally, the proximity sensor can include a light barrier that can detect a change in shape in a contactless manner. Furthermore, an ultrasonic sensor or another sensor can additionally or alternatively be used to detect a change in the shape of the portion pack.

The proximity sensor is preferably attached to a moveable part of the machine, for example a moveable supply line for hot water. This allows the detection or monitoring of different areas by moving the part.

In the method according to the invention for the preparation of a brewed beverage, an outer shape of the portion pack is detected via a proximity sensor for controlling the preparation of the brewed beverage, which can be designed depending on the outer shape of the portion pack. The proximity sensor can be used to detect different states of the portion pack during the brewing process, which can influence the programme sequence during beverage preparation if required. In this way, the entire system can be synchronised, even if no fixed programming is possible, either to enable the integration of manual steps or to optimise the timing, because waiting is only required exactly as long as is absolutely necessary.

Preferably, a closed shape and an open shape of the portion pack are detected via the proximity sensor to ensure that the portion pack is sufficiently open for the preparation process when a supply line of hot water is used. Then a supply of hot water to the portion pack at the start of the preparation process can only be permitted via the controller if a closed shape of the portion pack is detected. The portion pack can be brought into an open position by the addition of hot water, for example by swelling processes or by unlocking closure elements, which are then swivelled. Further supply of hot water during the preparation process can only take place by the controller if a transition of the portion pack from a closed to an open position is detected up to a certain point.

A supply of hot water onto the portion pack for a brewing procedure can only take place with the detection of an open position and extraction material that has not yet been brewed. This can optionally be detected by whether the opened portion pack has a smaller or larger volume and/or a different shape, for example a crater shape after preparation. This can also prevent the supply line of hot water, for example, if an already brewed portion pack is arranged in the holder.

The invention is explained in more detail below with reference to the accompanying drawings. It is shown in:

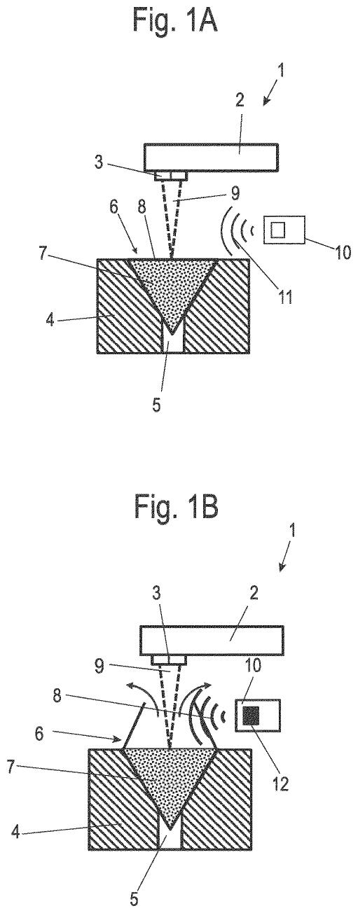

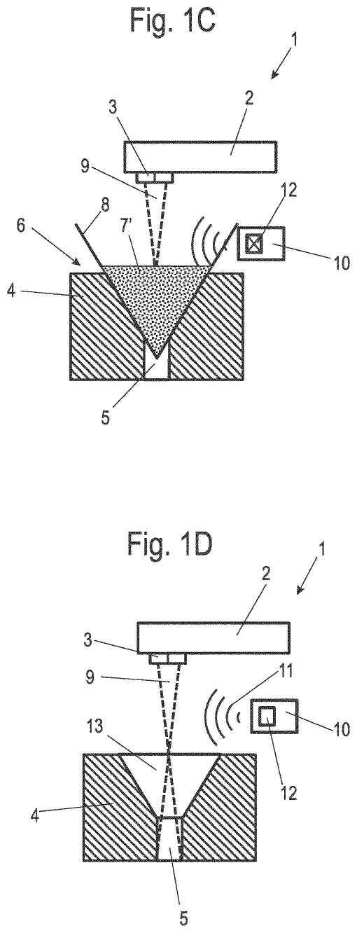

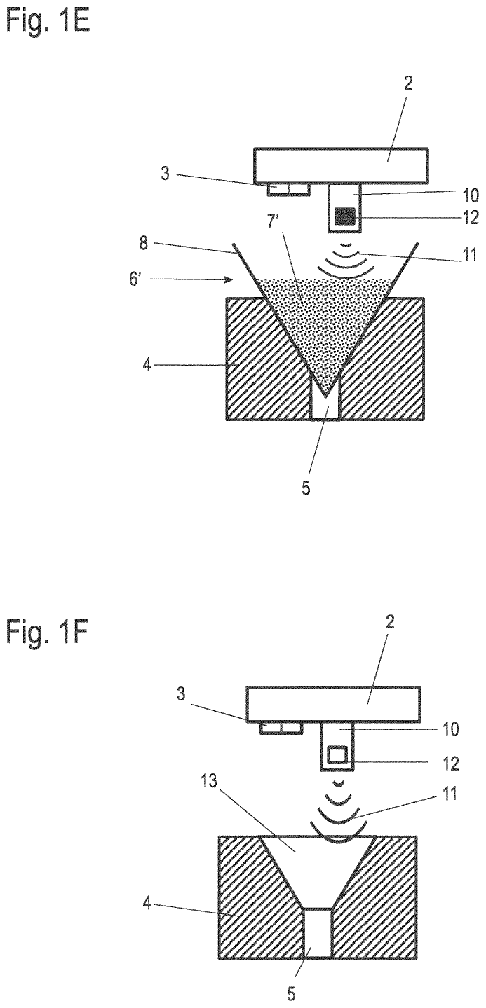

FIGS. 1A to 1D several schematic views of a machine for the preparation of a brewed beverage during the preparation process;

FIGS. 1E and 1F two views of the machine of FIGS. 1A to 1D in a modified variant;

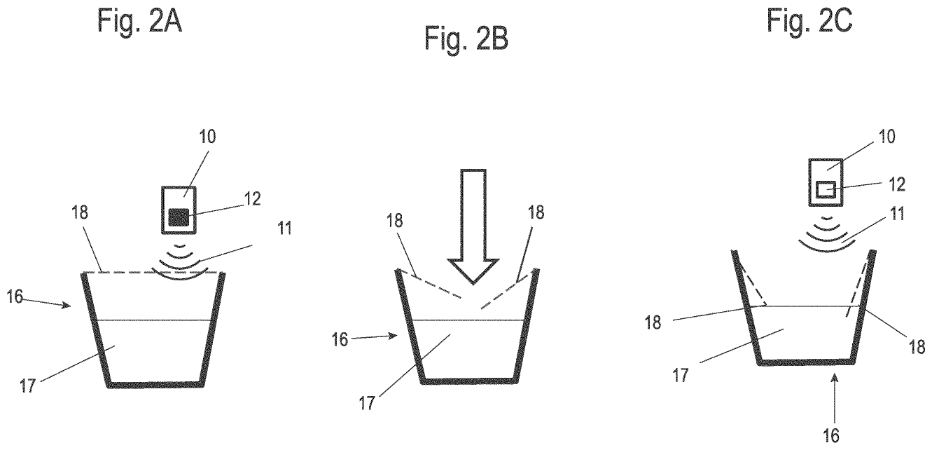

FIGS. 2A to 2C several views of a modified detection of the outer shape of a portion pack;

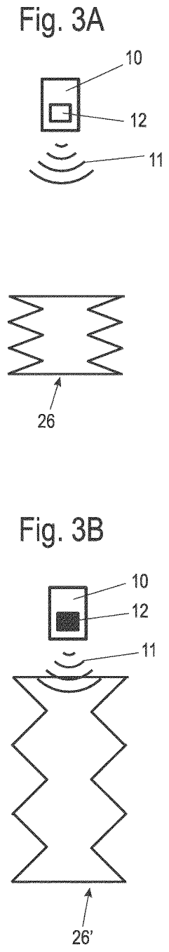

FIGS. 3A and 3B two schematic views for the detection of the outer shape of another portion pack, and

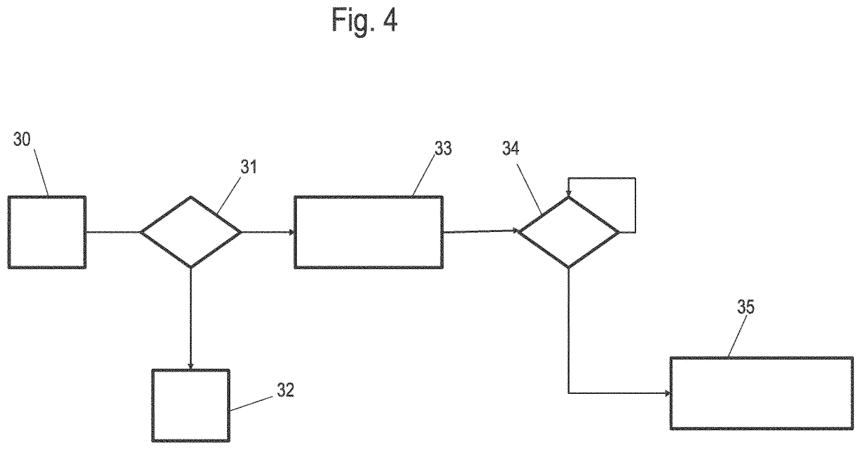

FIG. 4 a flow chart for a brewing process.

A schematically illustrated machine 1 for the preparation of a brewed beverage includes a supply line 2 for hot water, which is connected to a device for conveying and heating water, which can be operated via a control device. An outlet 3 is provided on the supply line 2 for hot water, which is arranged above a holder 4 comprising a receptacle for inserting a portion pack 6. Hot water 9 can thus flow out of the outlet 3 onto a top side 8 of the portion pack 6, in which an extraction material 7 is arranged, in particular coffee or tea. An outlet channel 5 is provided on the holder 4 so that the brewed beverage can be collected in a container.

The portion pack 6 is closed at the top side 8 via a plurality of closure elements and can be inserted into the holder 4 in a closed state. The portion pack can be formed as disclosed in DE 10 2018 101 337, to which reference is hereby made. In particular, the portion pack 6 can be opened automatically by applying hot water 9, for example by wetting a closure means with water and dissolving it and/or applying hot water to a folding edge, which then swivels the closure means to open it due to swelling processes.

A proximity sensor 10 is provided adjacent to the holder 4, which detects an outer contour of the portion pack 6 and the holder 4 in a contactless manner. The proximity sensor 10 can, for example, be formed as a capacitive sensor that evaluates a schematically depicted electromagnetic field 11.

If hot water is applied to the portion pack 6 via the supply line 2, a closing element in the shape of flaps can swing open automatically, as shown in FIG. 1B. This opens the portion pack 6 and the extraction material 7 becomes accessible from above. This opening process can be detected by the proximity sensor 10 because at least one closure element moves into the range of the electromagnetic field 11, thereby enabling detection in order to distinguish between the closed state (FIG. 1A) and an open position (FIG. 1B). A display 12 can be provided on the proximity sensor 10, which indicates the open state of the portion pack 6, and the sensor can forward this information to the controller for the machine for the preparation of a brewed beverage.

After the portion pack 6 can be opened, a brewed beverage can now be prepared by adding hot water 9 to the extraction material 7 via the supply line 2 and outlet 3 to then collect the brewed beverage in a container via the outlet channel 5.

FIG. 1C shows the portion pack 6 after the brewing procedure. The portion pack 6 is in an open position, as the closure elements are swivelled upwards. In addition, the volume of the extraction material 7′ is increased because the wetting with water has triggered swelling processes, so that the extraction material 7′ comprises a larger volume after the brewing procedure than before the brewing procedure. This volume change can be detected by the proximity sensor 10, so that the display 12 can indicate that the portion pack 6 is in an open position and also that a brewing procedure has already taken place. This can be passed on to a controller, for example to prevent the supply line of hot water now.

In FIG. 1D, the machine 1 for the preparation of a brewed beverage is shown without the portion pack 6, and it can be seen that a receptable 13 for the portion pack 6 is formed on the holder 4. In this position, it can be detected via the proximity sensor 10 that no portion pack 6 is arranged in the receptable 13.

FIGS. 1E and 1F show a modified embodiment compared to the previous embodiment example, in which the proximity sensor 10 is held on the supply line 2 for hot water. The supply line 2 can be moveable via a drive, so that the hot water can be applied over different areas of the top side of the portion pack 6. Accordingly, the proximity sensor 10 can also detect different areas via a movement of the supply line. In FIG. 1E, the portion pack 6 is shown in an open position, as the closure elements are swivelled upwards. The extraction material 7′ in the portion pack 6 has a larger volume than before the brewing procedure. This volume change was detected by the proximity sensor 10, which is visualised on the display 12.

FIG. 1F shows the empty holder 4 without portion pack 6. The proximity sensor 10 can detect from above that there is no portion pack 6 in the receptable 13. By arranging the proximity sensor 10 above the portion pack 6, it is possible to better monitor the opening of all closure elements, which are preferably arranged circumferentially, when the portion pack 6 is opened.

In addition, the supply line 2 can be removed from the position exactly above the holder 4 after the brewing procedure, so that the receptable 13 with the portion pack 6 is accessible from above and it can be removed and inserted more easily.

FIG. 2A shows a modified portion pack 16 which is formed in the shape of a bowl, in particular with a truncated cone-shaped container which is closed at a top side 18. The portion pack 16 contains an extraction material 17. According to FIG. 2A, the closed portion pack 16 can be detected via a proximity sensor 10, wherein the proximity sensor 10 is arranged adjacent to the top side 18. If the portion pack 16 is now opened, for example by mechanical influences or by the addition of hot water or by other opening methods, the shape of the top side 18 is changed, as shown in FIG. 2B. This change in shape can be detected by the proximity sensor 10, so that the controller of the machine can now receive a signal that the portion pack 16 is in an open state. In FIG. 2C, the portion pack 16 is shown in a fully open state, which is recognised by the proximity sensor. In addition, a further measurement can optionally take place after the brewing procedure, which detects an increase in volume of the extraction material 17 via the proximity sensor 10 and transmits this to the controller of the machine. The closure element on the top side 18 of the portion pack 16 can be formed from thin paper or from a film, for example a water-soluble film. The top side 18 can be cut or destroyed or otherwise opened. The cover of the top side 18 can be removed completely, for example via a. The cover of the top 18 can be formed completely, for example via a lid, or in sections, for example via a narrow band.

FIGS. 3A and 3B show a further embodiment of a portion pack 26, which is at least partially filled with extraction material and can be changed in shape between a compressed position as shown in FIG. 3A and an expanded position as shown in FIG. 3B. For example, the portion pack 26, 26′ can be compressed or enlarged for the preparation process. This change in the external geometry can be detected by the proximity sensor 10, as described above.

FIG. 4 shows a flow diagram for a brewing process of a machine for the preparation of a brewed beverage. In a first step 30, the machine is put into operation so that a portion pack 6 can be inserted into the holder 4. A measurement 31 is then taken, and the state of the inserted portion pack can be stored, in particular in order to have a comparative value at a later point in the brewing process. After measurement 31, a brewing step 33 is then carried out, for example opening the portion pack, which causes the portion pack to change shape. This step can either be performed automatically by the machine or manually by a user. In the next step 34, a further measurement is carried out and a check is made as to whether the portion pack has a different shape to the first measurement 31. If this is not the case, the controller can repeat the measurement or even the opening process. If it is determined that the shape of the portion pack has changed and that it is in an open position, hot water can now be introduced via the supply line 2 in step 35 in order to initiate the brewing procedure.

Various sensors, which enable contactless detection of a change in shape of the portion pack 6, 16, or 26, can be used as proximity sensor 10. Several sensors of the same type or several sensors of different types, which supply the controller with corresponding information, can also be used.

### LIST OF REFERENCE SIGNS

1 Machine
2 Supply line
3 Outlet
4 Holder
5 Outlet channel
6 Portion pack
7, 7 Extraction material
8 Top
9 Hot water
10 Proximity sensor
11 Electromagnetic field
12 Display
13 Receptable
16 Portion pack
17 Extraction material
18 Top
26, 26′ Portion pack
30 first step
31 Measurement
33 Brewing step
34 Step
35 Step

1: A machine (1) for the preparation of a brewed beverage, comprising:
a device configured for generation of heated water, said device being operable via a controller,
a holder (4) configured for holding a portion pack (6, 16, 26) with an extraction material, the holder (4) being arranged below a supply line (2) configured for supplying the heated water, and
a recognition unit, wherein the recognition unit includes a proximity sensor (10) that is configured to detect in a contactless manner a first shape of the portion pack (6, 16, 26) and a second shape of the portion pack (6, 16, 26), which is different from the first shape.

2: The machine according to claim 1, wherein the first shape of the portion pack (6, 16, 26) corresponds to a closed state of the portion pack (6, 16, 26).

3: The machine according to claim 1, wherein the second shape of the portion pack (6, 16, 26) corresponds to an opened state of the portion pack (6, 16, 26) before a brewing procedure.

4: The machine according to claim 1, wherein a third shape of the portion pack (6, 16, 26) corresponds to an opened state of the portion pack (6, 16, 26) after a brewing procedure.

5: The machine according to claim 1, wherein the proximity sensor (10) is configured to detect a volume change of the extraction material before and after a brewing procedure.

6: The machine according to claim 1, wherein the proximity sensor (10) includes a capacitive proximity sensor.

7: The machine according to claim 1, wherein the proximity sensor (10) includes a light barrier.

8: The machine according to claim 1, wherein the proximity sensor (10) comprises an ultrasonic proximity sensor.

9: The machine according to claim 1, wherein the proximity sensor (10) is attached to a moveable part of the machine and thus is configured to detect different areas.

10: A method for the preparation of a brewed beverage comprising the following steps:
inserting a portion pack (6, 16, 26) with an extraction material (7, 17) into a holder (4) of a machine (1) for preparation of a brewed beverage,
supplying heated water via a supply line (2) onto the extraction material (7, 17) in the portion pack (6, 16, 26) and preparing the brewed beverage,
detecting an outer shape of the portion pack (6, 16, 26) via a proximity sensor (10), and
controlling the preparation of the brewed beverage depending on the detected outer shape of the portion pack (6, 16, 26).

11: The method according to claim 10, wherein a closed shape of the portion pack (6, 16, 26) and an open shape of the portion pack (6, 16, 26) are detected via the proximity sensor (10).

12: The method according to claim 11, wherein the step of supplying the heated water onto the portion pack (6, 16, 26) at the start of a preparation process takes place only upon detection of a closed shape of the portion pack (6, 16, 26).

13: The method according to claim 12, wherein a further supply of heated water during the preparation process takes place only if a transition of the portion pack (6, 16, 26) from a closed to an open position is detected.

14: The method according to claim 11, wherein a supply of heated water onto the portion pack (6, 16, 26) for a brewing procedure takes place only upon detection of an open position and an extraction material that has not yet been brewed.
